(19) United States
(12) Patent Application Publication
(10) Pub. No.: US 2011/0036696 A1
(43) Pub. Date: Feb. 17, 2011

(54) ELECTRICAL SWITCH COMPRISING A PUSHBUTTON FIXED BETWEEN A FILM AND A CONTACTOR

(75) Inventors: Jean-Christophe Villain, Dole (FR); Michel Cour, Sampans (FR); Thierry Burnel, Dole (FR)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/854,642

(22) Filed: Aug. 11, 2010

(30) Foreign Application Priority Data
Aug. 11, 2009 (EP) 09167595.9

(51) Int. Cl. H01H 13/14

(52) U.S. Cl. 200/341

(57) ABSTRACT

The invention proposes an electrical switch (10) comprising:
a horizontal bottom plate (12), the horizontal top face (12s) of which supports at least two electrical contacts (16);
a contactor (14) which is placed on the top face (12s) of the bottom plate (12) and which can be elastically deformed to electrically link the two electrical contacts (16);
a pushbutton (24) which is positioned vertically above the contactor (14) and which can be manually displaced downward to provoke the elastic deformation of the contactor (14); and
an elastic film (32) which consists of a elastic film protecting the contactor (14) which covers the contactor (14) and the pushbutton (24), which is fixed to the top face (12s) of the plate (12), so as to secure the contactor (14) vertically on the plate (12),
characterized in that the pushbutton (24) is secured on the top portion (14s) of the contactor (14), and in that the elastic film (32) is secured on the top portion (14s) of the contactor (14) and secured on the top section (24s) of the pushbutton (24).

### RELATED APPLICATION AND CLAIM OF PRIORITY

This application claims the priority benefit of European Patent Application No. 09167595.9 filed Aug. 11, 2010, the content of which is incorporated herein by reference.

### BACKGROUND

The present disclosure relates to an electrical switch, also called an electronic switch, with reduced vertical bulk.

A conventional switch consists of a vertical stacking of various components. The vertical bulk of the switch is therefore determined by adding together the vertical dimensions and thicknesses of the components of the switch. To reduce this vertical bulk of the switch, it has been proposed to eliminate vertical play between the components, so that they are directly in contact with each other. It has also been proposed to reduce the vertical dimension or thickness of each component of the switch. However, reducing the dimensions of a component also reduces its mechanical resistance or strength, which can then strongly affect the life of the switch. Furthermore, for keeping the pushbutton in position on the contactor, it has been proposed to stick or glue the elastic film on top of the pushbutton. The pushbutton is then positioned with respect to the contactor by means of the elastic film.

U.S. Pat. No. 4,794,215 discloses such a switch, in which the elastic film is also used to provide a dust proof seal. The horizontal dimensions of the pushbutton are relatively small compared to the dimensions of the contactor and the elastic film. Then, the pushbutton can be removed easily from the elastic film, because of lateral solicitations on the pushbutton.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

The goal of the invention is to propose an electrical switch comprising means for holding the pushbutton in position with respect to the contactor, the design of which makes it possible to limit the vertical bulk of the switch, without compromising the operation of the switch.

To this end, the present disclosure proposes a switch comprising a horizontal bottom plate having a horizontal top face of supporting at least two electrical contacts; a contactor placed on the top face of the bottom plate and configured to be elastically deformed to establish an electrical link between the at least two electrical contacts; an intermediate pushbutton positioned vertically above the contactor and configured to be manually displaced downward to provoke an elastic deformation of the contactor; and an elastic film configured to protect the contactor, the elastic film covering the contactor and the pushbutton, wherein the elastic film is fixed to the top face of the plate, securing the contactor vertically on the plate. The switch is further characterized in that the pushbutton is secured on the top portion of the contactor and the elastic film is secured on the top portion of the contactor and on the top section of the pushbutton.

According to additional embodiments of the invention: the bottom face of the elastic film is covered with glue; the elastic film covers the contactor and the pushbutton, and the elastic film is secured to the pushbutton and to the contactor by gluing; the pushbutton is secured on the top portion of the contactor by gluing; the pushbutton is horizontally positioned and secured vertically relative to the contactor by joining the bottom section of the pushbutton directly to the top portion of the contactor; and the top face of the bottom plate includes an overall cylindrical recess, having a vertical main axis, the horizontal bottom of which supports the electrical contacts and the contactor.

### BRIEF DESCRIPTION OF THE DRAWINGS

Other features and advantages of the invention will become apparent from reading the detailed description which follows, for the understanding of which the reader should refer to the appended drawings, in which:

FIG. 1 is a schematic representation, in an exploded perspective view, of a switch according to the invention; and

FIG. 2 is an axial cross section of the switch represented in FIG. 1.

### DETAILED DESCRIPTION

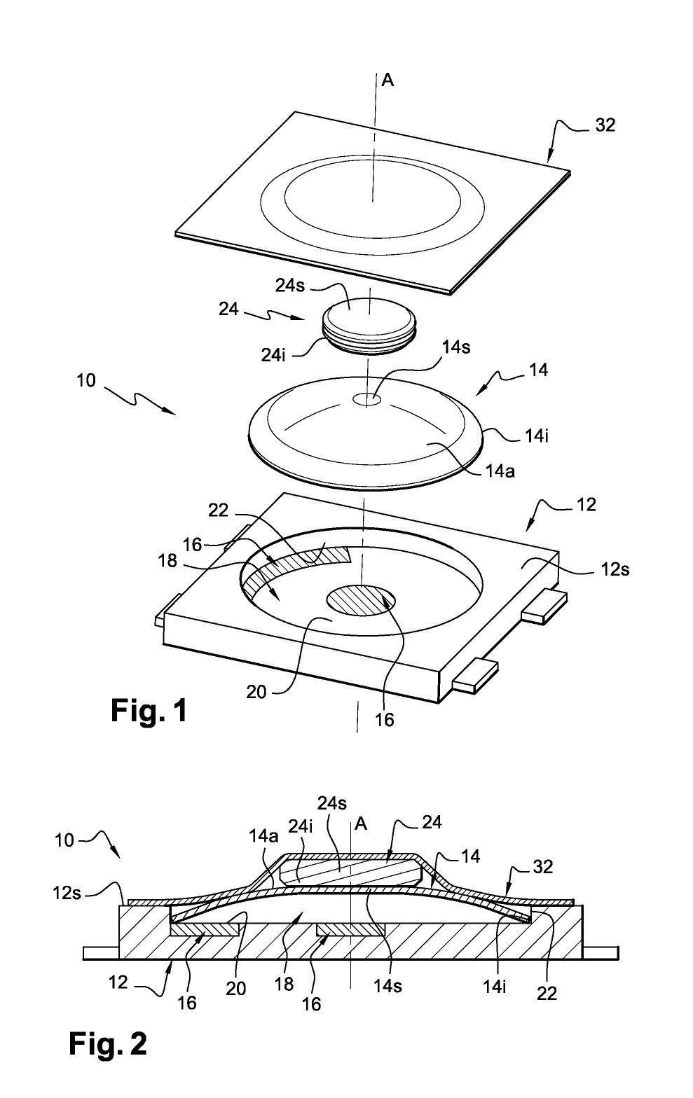

In the following description, the terms vertical, up, down, top, bottom, etc. will be used with reference to the vertical axis of FIGS. 1 and 2 and without any limiting reference to the gravity.

The figures represent a switch 10 of the pushbutton type which may be designed to be fitted on its own in an electronic or electrical appliance, such as, for example, a portable radio telephone or a computer, and more particularly in a keyboard of the electronic appliance.

The switch 10 may comprise a support plate 12 which consists of an overall flat horizontal plate. Two electrical contacts 16 may be fitted on the plate 12 and can be electrically linked or connected when the user acts on the switch 10 with a view to controlling the electronic appliance.

The plate may support a contactor 14 made of electrically conductive material which is fitted on the plate 12 and which is elastically deformable between a rest position and state illustrated in the figures and a position and state of actuation of the switch 10, in which it electrically connects the electrical contacts 16. The contactor or switching element 14 may also be made of a non conductive material, but having a conductive layer facing the electrical contacts.

According to a preferred embodiment, the contactor 14 may consist of an element of revolution having vertical main axis A and it is of upwardly dished convex shape forming a dome. The circular bottom base 14i of the dome-shaped contactor 14 may be in permanent contact with one of the two electrical contacts 16, and the top and central portion 14s, or summit, of the contactor 14 moves downward with respect to the plate 12 when the contactor 14 is deformed, so that the top portion 14s of the contactor 14 can come into contact with the other electrical contact 16, which is aligned with the other electrical contact, when the user acts on the switch 10.

To permit an electronic appliance to be produced with small dimensions, the dimensions of the contactor 14 may be small, for example, its external diameter is of the order of a few millimetres. Because of the small dimensions of the contactor 14, manipulating the contactor 14 to fit it on the bottom plate 12 may be rendered difficult.

To facilitate the positioning of the contactor 14 on the plate 12, the top face 12s of the plate 12 may include an overall vertical recess 18 in which the contactor 14 is received. The electrical contacts 16 may be positioned on the bottom 20 of the recess 18 and the contactor 14 is placed on the bottom 20 of the recess 18.

The recess 18 is produced in such a way as to precisely position the contactor 14 horizontally on the plate 12. The recess 18 is thus of a shape complementing the shape of the contactor 14 and the contactor 14 is received with a reduced horizontal play relative to the cylindrical vertical wall 22 of the recess 18, to allow for the necessary radial expansion of the contactor 14 when the latter is deformed.

The deformation of the contactor 14 may be obtained by means of an action from a user on an actuator (not represented) which is positioned above the contactor 14 and which is fitted to move vertically relative to the switch 10 between a top rest position in which the actuator is not acting on the contactor 14, and a bottom actuation position in which the actuator bears downward against the contactor 14, and provokes a deformation of the contactor 14.

When the actuator is in the bottom actuation position, the contactor 14 may then be in its bottom actuation position and state, in which it may establish an electrical link between the two electrical contacts 16.

According to yet another aspect of the contactor 14, the latter may form a disengageable end-stop for the actuator when it is in the top position, so that when the pressing force of the user is greater than a predetermined pressing force, the contactor 14 is abruptly deformed to come into its bottom actuation position, in which it electrically links the two electrical contacts 16.

On this abrupt deformation, the user may sense a rapid modification of the displacement resistance which is transmitted by the actuator, and which is likened by the user to a “click” of the switch 10.

When the contactor 14 is in its bottom position, it may be deformed so that its top portion 14s is situated below the top face 12s of the plate 12.

As stated above, the external diameter of the contactor 14, and consequently the internal diameter of the recess 18, may be relatively small. However, to allow a user to act on the actuator with one finger, the horizontal dimensions of the actuator may be greater than the diameter of the contactor 14 and of the recess 18.

Thus, when the contactor 14 and the actuator are displaced towards the actuation position of the switch 10, the actuator may abut against the top face 12s of the plate 12 before the contactor 14 is sufficiently deformed to electrically link the electrical contacts 16. Then, the switch 10 may not operate reliably and effectively. This is why the switch 10 may comprise an intermediate pushbutton 24 which is arranged vertically between the contactor 14 and the actuator. The pushbutton 24 then may make it possible to transmit the actuation forces between the actuator and the contactor 14.

The pushbutton 24 also may make it possible to concentrate the pressure forces produced by the user on the actuator, in a central zone of limited area of the contactor 14 which, in this case, is the top portion 14s of the contactor 14.

The pushbutton 24 may be positioned roughly coaxially to the vertical axis A of the contactor 14 and its diameter is less than the diameter of the contactor 14. The pushbutton 24 may thus be able to be displaced within the recess 18 and its height is determined so that, when the actuator and the contactor 14 are in the bottom actuation position, a top section 24s of the pushbutton 24 projects vertically upward relative to the top face 12s of the plate 12, so enabling the actuator to act on the contactor 14.

The bottom section or portion 24i of the pushbutton 24 may be in direct contact with the top portion 14s of the contactor 14.

The switch 10 may also comprise a top elastic sheet 32 which covers the contactor 14 and which covers the pushbutton 24, and which also partly covers the top face 12s of the plate 12.

The elastic sheet 32 may consist of an elastic film for protecting the contactor 14 and the electrical contacts 16, to prevent any polluting element such as dust or damp from penetrating into the recess 18. Hereinafter, the elastic sheet 32 will be designated by “elastic film”.

The elastic film 32 may be fixed to the top face 12s of the plate 12, for example by gluing, and the elastic film 32 bears downward against the top face 14a of the contactor 14 and against the top section 24s of the pushbutton 24. Thus, the elastic film 32 may make it possible to provide, on the one hand, the internal seal-tightness of the switch 10 and, on the other hand, the elastic film makes it possible to secure the contactor 14 and the pushbutton 24 vertically in the recess 18.

The elastic film 32 may be elastically deformable so that, when the user acts on the actuator, the elastic film 32 is deformed when the contactor 14 is deformed. This may make it possible to maintain the seal-tightness of the closure of the recess 18.

According to the invention, the pushbutton 24 may be horizontally positioned and secured vertically relative to the contactor 14 by joining the bottom section 24i of the pushbutton 24 directly to the top portion 14s of the contactor 14, for example by gluing.

According to a second aspect of the invention, the elastic film 32 may cover the contactor 14 and the pushbutton 24, and the elastic film 32 is secured to the pushbutton 24 and to the contactor 14, for example by gluing.

In a preferred embodiment, the bottom face of the elastic film may be entirely covered with glue so that it is directly stuck to the contactor 14 and to the pushbutton 24. The elastic film 32 may be elastically deformable so that it is capable to come into contact with the top portion 14s of the contactor 14, in the vicinity of the bottom section 24i of the pushbutton 24.

Then, the pushbutton 24 may be secured to the top on the contactor 14 and to the elastic film 32, so that the pushbutton 24 can not be removed because of the lateral solicitations on the pushbutton 10.

The contactor or switching dome may be “double”, i.e. made of two superposed domes. The present disclosure also concerns a switch comprising two adjacent contactors or switching domes. The present disclosure also concerns a navigator including more, i.e. one to five adjacent domes arranged in a support plate.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. An electrical switch comprising:
a horizontal bottom plate comprising a horizontal top face supporting at least two electrical contacts;
a contactor positioned on the top face of the bottom plate and configured to be elastically deformed to establish an electrical link between the at least two electrical contacts;
an intermediate pushbutton positioned vertically above the contactor and configured to be manually displaced downward to provoke an elastic deformation of the contactor; and
an elastic film configured to protect the contactor, the elastic film covering the contactor and the pushbutton, wherein the elastic film is fixed to the top face of the plate thereby securing the contactor vertically on the plate;
wherein the pushbutton is secured on the top portion of the contactor and the elastic film is secured on the top portion of the contactor and on the top section of the pushbutton.

2. The switch of claim 1, wherein the bottom face of the elastic film is covered with glue.

3. The switch of claim 2, wherein the elastic film covers the contactor and the pushbutton, and in that the elastic film is secured to the pushbutton and to the contactor by gluing.

4. The switch of claim 1, wherein the pushbutton is secured on the top portion of the contactor by gluing.

5. The switch of claim 4, wherein the pushbutton is horizontally positioned and secured vertically relative to the contactor by joining the bottom section of the pushbutton directly to the top portion of the contactor.

6. The switch of claim 1, wherein the top face of the bottom plate comprises an overall cylindrical recess having a vertical main axis and a horizontal bottom configured to support the electrical contacts and the contactor.
